(19) United States
(12) Patent Application Publication
(10) Pub. No.: US 2026/0015515 A1
(43) Pub. Date: Jan. 15, 2026

(54) Ultraviolet and Visible Light Responsive Coatings Using Redox-Active Colorants and Semiconductors

(71) Applicant: Northeastern University, Boston, MA (US)

(72) Inventors: Daniel J. Wilson, Medford, MA (US); Cassandra Leigh Martin, Wilmington, MA (US); Kaitlyn R. Flynn, Clarkston, WA (US); Rachel C. Malampy, Burlington, MA (US)

(21) Appl. No.: 19/263,865

(22) Filed: Jul. 9, 2025

Related U.S. Application Data
(60) Provisional application No. 63/669,195, filed on Jul. 9, 2024.

(51) Int. Cl. C09D 7/62; C09B 19/00; C09B 21/00; C09B 59/00; C09D 5/32; C09D 7/41; C09D 7/65

(52) U.S. Cl. CPC C09D 7/62; C09B 19/00; C09B 21/00; C09B 59/00; C09D 5/32; C09D 7/41; C09D 7/65

(57) ABSTRACT

A composition of tin-doped titanium dioxide (Sn—TiO₂) particles, a redox-active dye that changes color from exposure to ultraviolet (UV) light, visible light, or a combination thereof, and a paint matrix, along with methods of making the composition and uses of the composition are described herein. Compositions of TiO₂ particles, wherein the TiO₂ particles are at least 80% anatase or at least 80% rutile, in combination with a redox-active dye that changes color from exposure to ultraviolet (UV) light, visible light, or a combination thereof, and a paint matrix are also described herein.

### RELATED APPLICATION

This application claims the benefit of U.S. Provisional Application No. 63/669,195, filed on Jul. 9, 2024. The entire teachings of the above application(s) are incorporated herein by reference.

### BACKGROUND

A number of color-changing consumer goods are currently available. In the apparel and textile industries, several thermochromic dyes have been incorporated into clothing and fabrics to create controlled and vibrant changes in fabric color. While the leuco dyes and liquid crystal materials that enable thermochromic performance offer reproducible color switching, these technologies can require substantial energy from an outside source to function. In cases where localized heating is not possible or preferred, using natural/ambient sources of energy (e.g., sunlight) can be preferred.

Photochromic dyes can undergo reversible changes in their chemical structure (e.g., cis-trans isomerization or ring opening/closure reactions) in response to light, typically ultraviolet light. These molecules are the basis of color and opacity changing lenses for glasses (e.g., transition lenses) and have been improved since their introduction to offer a broader color palette and formulation/application vehicles (e.g., paints). The color transitions of these formulations are generally rapid (circa one hour).

Iridescent paint products have been advertised as “color-changing” (e.g., chameleon paints), but the perceived color of these coatings is dependent on the viewing angle at which an observer inspects a painted surface. In this example, perceived color is not easily controlled and the observed color changing effect varies considerably based on the relative positions of the painted surface and the observer.

Accordingly, there is a need for additional paint formulations, particularly those in which the dye does not require high levels of energy applied to the paint that can be controlled and observed by an observer.

### SUMMARY

Described herein are compositions that includes tin-doped titanium dioxide (Sn—TiO₂) particles, a redox-active dye that changes color from exposure to ultraviolet (UV) light, visible light, or a combination thereof, and a paint matrix. Also described are methods of making and using the composition. In some instances, the composition can be used as a paint or added to a paint. In some other instances, the composition can be combined with another material to confer color changing properties on the material.

Also described is a composition that includes TiO₂ particles, wherein the TiO₂ particles are at least 80% anatase, a redox-active dye that changes color from exposure to ultraviolet (UV) light, visible light, or a combination thereof, and a paint matrix. In some embodiments, the anatase TiO₂ particles exhibit a color change of a ΔE of about 3.0 to about 48.0 after irradiation by about 2 J/cm² of UV light over a short period of time before reverting to the original color.

Also described is a composition that includes TiO₂ particles, wherein the TiO₂ particles are at least 80% rutile, a redox-active dye that changes color from exposure to ultraviolet (UV) light, visible light, or a combination thereof, and a paint matrix. In some embodiments, the rutile TiO₂ particles may exhibit a color change of a ΔE of about 1.0 to about 2.0 after irradiation by about 2 J/cm² of UV light over an extended period of time before reverting to the original color.

Described herein is a composition of a dye (e.g., methyl viologen) and particles (i.e. Sn—TiO₂, TiO₂ particles of at least 80% anatase, TiO₂ particles of at least 80% rutile) in formulations to rapidly change the color of coatings from clear/white to purple within seconds of UV irradiation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A and 1B are representative images of Xanthommatin coatings with large and small particles of anatase (FIG. 1A) and rutile (FIG. 1B) as the whitening agent before an after UV irradiation at three different loading densities.

FIGS. 1C and 1D are graphs of the change in hue angle of each condition with anatase (1C) and rutile (1D) particles over 30 J/cm² of irradiation. Results are an average of three sample replicates and error is the standard deviation.

FIG. 2 is a representative image of viologen based coatings with anatase TiO₂ particles (left) and rutile TiO₂ particles (right) before (top), after a 2 J/cm² dosage of UVA irradiation (center), and after a 30 J/cm² dosage of UVA irradiation (bottom). Two different particle sizes (small and large) were tested for each TiO₂ polymorph.

FIG. 3 is a representative image of color-changing coatings kinetics for Xanthommatin and TiO₂ (left) particles that exhibit a yellow to red shift over long timescales. Coatings of methyl viologen and TiO₂ (right) particles are capable of rapid transitions from clear to colorful states. Coatings were prepared on white backings.

FIG. 4 is a representative scanning-electron microscopy (SEM) image of synthesized TiO₂ particles.

FIG. 5 is a representative SEM image of synthesized Sn—TiO₂ particles.

FIG. 6 is schematic featuring images of color changes in coatings with Sn—TiO₂ particles and either methyl viologen (left), resazurin (middle), and methylene green (right) using blue light, green light, and red light, respectively.

FIG. 7A is representative images of a coating with Sn—TiO₂ particles and 2 mg/mL of methyl viologen, resazurin, and methylene green before exposure, after exposure at different timepoints, and after 24 hours of no visible light exposure.

FIG. 7B is a graph of the color changes in the coating with different colors of visible light over a 10-minute period. The coating color was measured using the RGB color space and the change in the channel that was most responsive to the irradiation (red channel) was reported.

FIG. 7C is a graph of the ΔE values of the coating after 5 minutes of irradiation and 24 hours of relaxation for each color of light.

FIG. 8A is an image of an acrylate-modified coating containing TiO₂ and additional colorants such as xanthommatin on a green fabric substrate.

FIG. 8B is an image of the results for the X-cut adhesive test for the flexible coatings on fabric. An X was cut into the coating with a razor blade and then adhesive tape was applied directly over the cuts and then quickly removed. Results show that no paint peeled off the substrate, illustrating the compatibility between the coating and substrate and receiving the highest rating for adhesive strength (5A).

FIG. 8C is a representative image of the flexible coatings containing the same molar ratios of Xa to anatase or rutile (smaller particles) as our previous Xa coatings (FIG. 1) before and after exposure to UV radiation to highlight the photoresponsive nature of the flexible coatings. Coatings were prepared on a white substrate.

FIG. 9 is a group of images of Sn—TiO₂ and 2 mg/mL of methyl viologen in a 15% gelatin solution (top left) exposed to UV light (top right) and polyacrylamide hydrogel (bottom left) exposed to blue light (bottom right). In both conditions the methyl viologen changed from a clear/yellow color to blue. The polyacrylamide hydrogel also cured with a different texture than the gelatin sample. These results were measured qualitatively and highlight color change in other types of materials.

### DETAILED DESCRIPTION

A description of example embodiments follows.

As used herein “about” means within an acceptable error range for the particular value, as determined by one of ordinary skill in the art. Typically, an acceptable error range for a particular value depends, at least in part, on how the value is measured or determined, e.g., the limitations of the measurement system. For example, “about” can mean within an acceptable standard deviation, per the practice in the art. Alternatively, “about” can mean a range of ±20%, e.g., ±10%, ±5% or ±1% of a given value. It is to be understood that the term “about” can precede any particular value specified herein, except for particular values used in the Exemplification.

### Compositions

Described herein are compositions that change color upon exposure to ultraviolet (UV) or visible light. In general, the compositions include titanium dioxide nanoparticles; a redox-active colorant (e.g., a pigment or dye); and a paint matrix. The titanium dioxide nanoparticles can be anatase titanium dioxide, rutile titanium dioxide, or tin-doped titanium dioxide (Sn—TiO₂). Generally speaking, these features can be combined together, so for example the teachings regarding paint matrices are applicable to all embodiments.

The TiO₂ particles (of either rutile or anatase) and the Sn—TiO₂ particles are typically nanoparticles. The term “nanoparticle” means a particle of matter that is between about 1 nanometer to about 1000 nanometers (nm) in diameter. A nanoparticle is also generally in a spherical shape, although it is possible for it to be in any three-dimensional shape that is between about 1 nm to about 1000 nm (e.g., a cube, rectangular prism, ellipsoid, spheroid). For example, the TiO₂ particles (or either rutile or anatase) can have an average diameter of about 840 nm to about 960 nm. The Sn—TiO₂ particles can have an diameter of about 150 nm to about 350 nm. Small particle anatase TiO₂ can be less that 25 nm, or about 20 nm to 25 nm. Small particle rutile TiO₂ can be less than 100 nm. Large particle anatase TiO₂ can have an average the particle size of 600 nm and/or 90% of the batch can be less than 1000 nm. Large particle rutile TiO₂ can be less than about 5000 nm, or from about 3000 nm to about 5000 nm.

### Sn—TiO₂ Particles

Described herein is a composition that includes tin-doped titanium dioxide (Sn—TiO₂) particles, a redox-active colorant or dye, and a paint matrix that changes color from exposure to ultraviolet (UV) light, visible light, or a combination thereof.

Typically, the Sn—TiO₂ particles are nanoparticles. In some further aspects, the Sn—TiO₂ particles have an average diameter of about 150 nm to about 350 nm. In some further aspects, the Sn—TiO₂ particles have an average diameter of about 200 nm to about 275 nm.

In some aspects, the Sn—TiO₂ particles have a normalized weight percentage of tin of about 10% to about 50%. In some aspects, the normalized weight percentage of tin is about 20% to about 35%. In some aspects, the normalized weight percentage of tin is about 25% to about 30%.

In some aspects, the Sn—TiO₂ particles may also contain chloride anions from the tin (II) chloride (SnCl₂) that is used to dope TiO₂ particles in a one-pot reaction. The normalized weight percentage of chloride anions is from about 0% to about 10%. In some aspects, the normalized weight percentage of the chloride anions is about 1% to about 7%. In some aspects, the normalized weight percentage of is chloride anions is about 4% to about 6%. Without being held to any theory, it is hypothesized that the chloride anions do not affect how visible light and UV light interact with the Sn—TiO₂ particles.

### Anatase Particles

Also provided herein is a composition that includes TiO₂ particles, wherein the TiO₂ particles are at least 80% anatase, a redox-active colorant or dye that changes color from exposure to UV light, visible light, or a combination thereof, and a paint matrix. The phrase “at least 80%” refers to about 80% to about 100% of the particles of the composition. Anatase is a mineral form of TiO₂ with a tetragonal crystal structure with a unit cell dimension of approximately α=3.784 Å and c=9.514 Å with a c/a ratio of about 2.514. In some aspects, anatase may appear as black, brown, yellow, blue, or gray. Anatase has a hardness of about 5.5 to about 6 on the Mohs hardness scale and is less dense and less hard than its polymorph rutile. In some aspects, the composition with at least 80% anatase TiO₂ particles may have a rapid color change reversion (i.e. about one minute, about two minutes, about three minutes, up to about five minutes).

In some aspects, the anatase is greater than or about 90% w/w of the particles, e.g., greater than or about 91% w/w, greater than or about 92% w/w, greater than or about 93% w/w, greater than or about 94% w/w, greater than or about 95% w/w, greater than or about 96% w/w, greater than or about 97% w/w, greater than or about 98% w/w, greater than or about 99% w/w, or about 100% w/w of the particles.

In some aspects, the color change of the composition with at least 80% anatase TiO₂ particles has a ΔE of about 3.0 to about 48.0 after irradiation by about 2 J/cm² of UV light and/or a ΔE of about 7.0 to about 40.0 after irradiation about 30 J/cm² of UV light. In some aspects, the hue angle shift for the composition with at least 80% anatase TiO₂ particles is from about 200 to about 45°. In some aspects, the hue angle shift for the composition with at least 80% anatase particles TiO₂ is from about 250 to about 40°.

Small particle anatase TiO₂ can be less that 25 nm, or about 20 nm to 25 nm. Large particle anatase TiO₂ can have an average the particle size of 600 nm and/or 90% of the batch can be less than 1000 nm.

### Rutile Particles

Further provided herein is a composition that includes TiO₂ particles, wherein the TiO₂ particles are at least 80% rutile, a redox-active colorant or dye that changes color from exposure to UV light, visible light, or a combination thereof, and a paint matrix. The phrase “at least 80%” refers to about 80% to about 100% of the particles of the composition. Rutile is a mineral form of TiO₂ with a tetragonal crystal structure with a unit cell dimension of approximately α=4.593 Å and c=2.959 Å with a c/a ratio of about 0.644. In some aspects, rutile may appear as reddish-brown, yellow, pale blue, or black. Rutile has a hardness of about 6.0 to about 6.5 on the Mohs hardness scale and is denser and harder than its polymorph anatase. In some other aspects, the composition with at least 80% rutile TiO₂ particles may have a color change reversion that occurs over an extended period of time (i.e. about one hour, about two hours, up to about 24 hours).

In some aspects, the rutile is greater than or about 90% w/w of the particles, e.g., greater than or about 91% w/w, greater than or about 92% w/w, greater than or about 93% w/w, greater than or about 94% w/w, greater than or about 95% w/w, greater than or about 96% w/w, greater than or about 97% w/w, greater than or about 98% w/w, greater than or about 99% w/w, or about 100% w/w of the particles.

In some aspects, the color change of the composition with at least 80% rutile TiO₂ particles has a ΔE of about 1.0 to about 2.0 after irradiation by about 2 J/cm² of UV light and/or a ΔE of about 3.0 to about 7.0 after irradiation by about 30 J/cm² of UV light. In some aspects, the hue angle shift for composition with at least 80% rutile TiO₂ particles is from about 2° to about 6°. In some aspects, the hue angle for the composition with at least 80% rutile TiO₂ particles is from about 3° to about 5.5°.

Small particle rutile TiO₂ can be less than 100 nm. Large particle rutile TiO₂ can be less than about 5000 nm, or from about 3000 nm to about 5000 nm.

### Redox-Active Colorants

A redox-active colorant (e.g., a dye or pigment) is a molecule that can be oxidized, reduced, or both oxidized and reduced by an electron transfer reaction. The redox-active dye is a color when it is in a neutral state and changes color upon being oxidized and/or reduced. Redox-active dyes may also exhibit electrochromic properties, meaning that their color can change when an electric current is applied. Compounds or molecules capable of participating in these types of redox reactions generally have chemical structures that can have multiple resonance structures (i.e. conjugated functional groups, atoms with empty or imbalanced d-orbitals). Some functional groups capable of participating in redox reactions include but are not limited to: alkenes, alkynes, aromatic rings, phenols, esters, ketones, alcohols, amides, and carboxylic acids.

Typically, the redox-active dye is soluble in water. In some aspects, the redox-active dye may be methyl viologen, resazurin, or methylene green. In some aspects, the redox-active dye may change color upon exposure to blue light, green light, or red light. In some aspects the blue light has a wavelength from about 450 nm to about 495 nm. In some aspects, the green light has a wavelength from about 495 nm to about 570 nm. In some aspects, the red light has a wavelength from about 620 nm to about 650 nm.

In some aspects, the redox-active dye is methyl viologen and the color change comprises a ΔE of about 33.4 and a change in hue angle of about +47.7°.

In some aspects, the redox-active dye is resazurin and the color change comprises a ΔE of about 4.1 and a change in hue angle of about −2.9°.

In some aspects, the redox-active dye is methylene green and the color change comprises a ΔE of about 14.5 and a change in hue angle of about −17.9°.

In some aspects, the composition may use multiple redox-active dyes.

In some aspects, the color change is temporary. For example, the color can revert to the original color (prior to exposure to ultraviolet or visible light) after about a minute. In some other aspects, the color reverts to the original color after about 24 hours. The length of time for the color change reversion may depend upon the dye that is present in the composition. In some other instances, the rate of reversion to the original color may be dependent upon the type of TiO₂ particles present in the composition.

In some aspects, the composition of the TiO₂ particles (of either rutile or anatase) further comprises a pigment. In some aspects, the pigment may be xanthommatin (Xa).

As used herein, “xanthommatin” refers to 11-(3-amino-3-carboxypropanoyl)-1,5-dioxo-4H-pyrido[3,2-a]phenoxazine-3-carboxylic acid. Xanthommatin and various of its precursors and derivatives can be extracted from cephalopods (e.g., squid Doryteuthis pealeii chromatophores) and other natural sources, such as the eyes, integumentary system, organs, and eggs of arthropods. Xanthommatin and its precursors and derivatives can also be synthesized using methods described herein and/or known in the art.

As described herein, the reversible change in oxidation state, with respect to xanthommatin, refers to the interchange of xanthommatin (left) and dihydroxanthommatin (right):

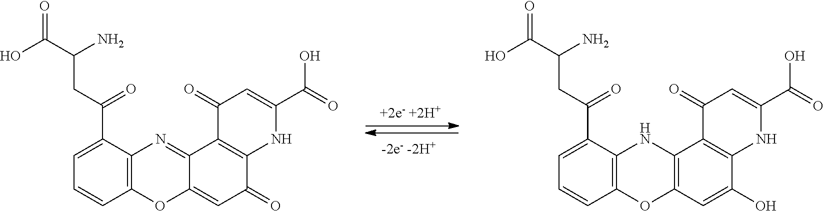 [SMILES: NC(CC(=O)c1cccc2oc3cc(=O)c4[nH]c(C(=O)O)cc(=O)c4c-3nc12)C(=O)O ; NC(CC(=O)c1cccc2c1Nc1c(cc(O)c3[nH]c(C(=O)O)cc(=O)c13)O2)C(=O)O]

The description regarding the redox-active colorants is applicable to all compositions described herein, e.g., the compositions comprising Sn—TiO₂ particles, compositions comprising anatase particles, and compositions comprising rutile particles.

### Paint Matrices

In some aspects, the composition is a paint, such as a water-based paint or an oil-based paint.

In some aspects, the paint matrix is a water-based paint matrix. For example, in some aspects, the paint matrix comprises a polymeric binder and water, as is typical, for example, in one-component paints. In some aspects, the polymeric binder is a polyurethane, polyamide, polyester, polysaccharide, polyethylene glycol, polyacrylate, polymethacrylate, or nitrocellulose. In some aspects, the polymeric binder is polyurethane. In some aspects, such as when the composition is for use as nail polish, the polymeric binder is nitrocellulose. When the polymeric binder is nitrocellulose an organic solvent is also usually included. Other polymeric binders for use in water-based paint matrices are known to those of skill in the art. In some aspects, the polymeric binder is a polyurethane. In some aspects, the polymeric binder is a polyacrylate. In some aspects, the water-based paint matrix is a water-based polyurethane paint matrix, such as a one-component, clear, water-based polyurethane paint matrix (e.g., Rust-Oleum® 6711 System Clear Water-Based Polyurethane). In some other aspects, the paint matrix can be a nail polish or nail paint.

In some aspects, the paint matrix comprises a reactive monomer or reactive pre-polymer and an aqueous solvent, as is typical, for example, in multi-component paint systems. In some aspects, the reactive monomer or reactive pre-polymer is urethane-based, amide-based, ester-based, saccharide-based, ethylene glycol-based, acrylate-based, or methacrylate-based. In some aspects, the reactive monomer or reactive pre-polymer is urethane-based. Other reactive monomers and reactive pre-polymers for use in water-based paint matrices for multi-component paint systems are known to those of skill in the art.

In some aspects, the paint matrix comprises a polymer. In some further aspects, the polymer can be nitrocellulose, methacrylate compounds, acrylic resins, or tosylamide-formaldehyde resin.

In some aspects, the water can include a buffer. In some aspects, the paint matrix may also comprise an organic solvent. Examples of buffers include: acetic acid with sodium acetate, ammonium hydroxide with ammonium chloride, citric acid with sodium citrate, carbonic acid with bicarbonate, and KH₂PO₄ with K₂HPO₄. Examples of organic solvents include: alkyl solvents (such as hexanes, cyclohexane, pentanes, and the like), aromatic solvents (such as benzene, toluene, and the like), alcohols (such as methanol, acidic methanol, ethanol, and the like), esters, ethers, and ketones (such as diethyl ether, acetone, and the like), amines (such as dimethyl amine and the like), and nitrated and halogenated hydrocarbons (such as dichloromethane, acetonitrile, and the like). In a particular aspect, the paint matrix comprises acidic methanol.

In some aspects, the paint matrix is an oil-based paint matrix. For example, in some aspects, the paint matrix comprises an oil and a non-aqueous solvent. In some aspects, the oil is a natural oil, such as linseed oil. In some aspects, the oil is a synthetic oil, such as alkyd.

In some aspects, the non-aqueous solvent is an organic solvent. In an embodiment, the organic solvent comprises turpentine or a mineral spirit.

In some aspects, such as when the composition is for use as nail polish, the paint matrix comprises nitrocellulose, usually (but not always) with an organic solvent.

In some aspects, the paint matrix is greater than or about 50% w/w of the composition, e.g., greater than or about 65%, greater than or about 75%, greater than or about 80%, greater than or about 85%, greater than or about 90%, or greater than or about 95%, w/w of the composition. In some aspects, the paint matrix is less than 100% w/w of the composition, e.g., less than or about 99%, less than or about 98%, less than or about 97%, less than or about 96%, less than or about 95%, less than or about 94%, less than or about 93%, less than or about 92%, less than or about 91%, less than or about 90%, or less than or about 85%, w/w of the composition. In some aspects, the paint matrix is about 50% to less than 100% w/w of the composition, e.g., 65% to less than 100%, about 75% to less than 100%, about 75% to about 95%, about 75% to about 85%, or about 80%, w/w of the composition.

The description regarding the paint matrices is applicable to all compositions described herein, e.g., the compositions comprising Sn—TiO₂ particles, compositions comprising anatase particles, and compositions comprising rutile particles.

### Methods of Making TiO₂ Particles

Described herein is a method to form the TiO₂ particles for the compositions. A mixture of methanol, acetonitrile, distilled water, and dodecylamine are thoroughly mixed together. During mixing, titanium (IV) isoproproxide is added and stirring is continued until the solution turns a milky white color, then centrifugation occurs followed by washing with ethanol, forming TiO₂ particles.

### Methods of Making Sn—TiO₂ Particles

Described herein is a method to form the Sn—TiO₂ particles. A mixture of methanol, acetonitrile, distilled water, and dodecylamine are thoroughly mixed together. During mixing, titanium (IV) isoproproxide is added and stirring is continued until the solution turns a milky white color, then tin (II) chloride is added to the stirring mixture. The milky white colored solution should turn a pale-yellow upon addition of the tin (II) chloride. The solution is stirred further for about 4 hour to about 16 hours. The solution is then centrifuged and washed with ethanol thereby forming Sn—TiO₂ particles.

### Methods of Making Compositions

The compositions described herein can be prepared according to the examples provided. As will be appreciated by the skilled artisan, preparation of the compositions is not limited to the examples. The compositions can be prepared by alterations to the examples provided or by alternative processes. The processes described herein can be used to produce the compositions described herein in milligram scale, gram scale, kilogram scale, or greater. The methods of making the composition are generally applicable regardless of the particles that are used.

Described herein is a method of making a composition (e.g. a paint, such as a water-based paint), such as a composition described herein, comprising dissolving particles (i.e. Sn—TiO₂ particles, TiO₂ particles that are at least 80% anatase, TiO₂ particles that are at least 80% rutile) with a redox-active dye that changes color from exposure to ultraviolet (UV) light, visible light, or a combination thereof in a paint matrix. A person skilled in the art can replace the particles in the methods described herein.

In some aspects, the process further comprises mixing the composition to uniformly distribute the redox-active dye, throughout the composition. Mixing can be accomplished, for example, by stirring, shaking, vortexing, sonicating, etc.

### Applications

All compositions described herein (i.e. compositions comprising Sn—TiO₂, compositions comprising anatase particles, compositions comprising rutile particles) are applicable for the uses described herein.

In some aspects, the composition further comprises a polyacrylamide hydrogel or precursors thereof, such as acrylamide and bis-acrylamide. In some other aspects, the composition further comprises gelatin.

In some aspects, the composition is adhered to a flexible substrate, for example, a flexible substrate formed of a fabric, a plastic, a rubber. In some aspects the composition is incorporated into a hydrogel,

In some instances, the flexible substrate can be a keratin containing composition, such as a fingernail or a toenail. The composition can also be adhered to an acrylic fingernail or toenail, a gel fingernail or toenail, or a press-on fingernail or toenail. In some instances, the composition changes color applied on the fingernail, toenail, acrylic fingernail or toenail, gel fingernail or toenail, or press-on fingernail or toenail in the presence of UV light, visible light, or a combination thereof.

In some aspects, any of the compositions described herein can be used in a paint, as a paint, in a coating, or as a coating for a material. In some further aspects, the paint can be a nail polish.

### EXEMPLIFICATION

### Example 1

In our previously published manuscript¹ and patent application,² we reported on bio-inspired photochromic coating formulations that leverage the redox properties of the biochrome xanthommatin (Xa) and the semiconductor titanium dioxide (TiO₂) to create vibrant color changes from yellow (oxidized Xa) to red (reduced Xa) in the presence of UV light. We determined that we could control the degree of color change by adjusting the density and particle size of the TiO₂ in the formulation. Recently, we expanded on our Xa-based photochromic coatings by exploring the effects of two different polymorphs TiO₂—anatase and rutile—at two different sizes of the color-changing capabilities of our coatings. Ultimately, our goal was to investigate if we could further control the degree of color change in our coatings by changing the form of TiO₂ that we used as our semiconductor and whitening pigment.

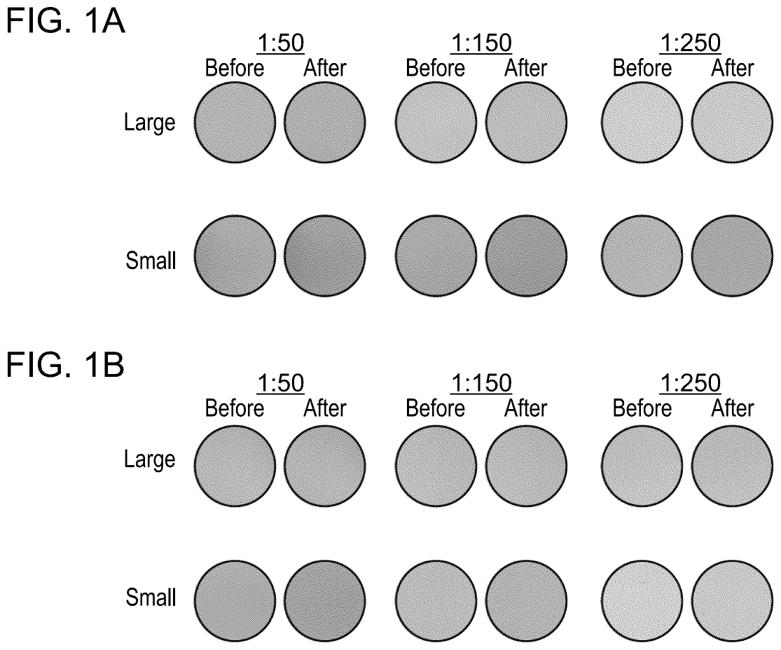

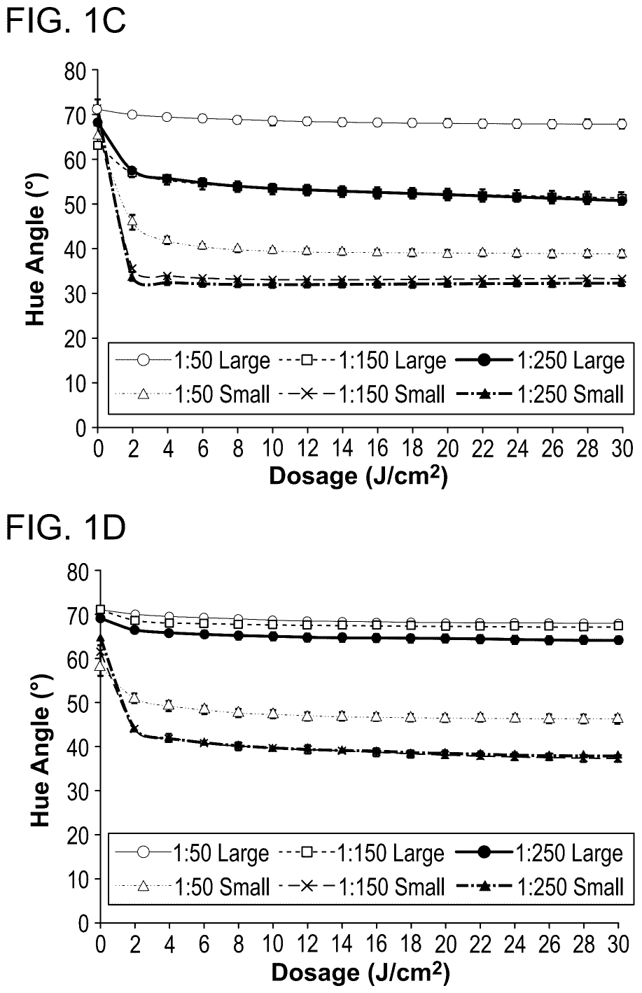

We prepared formulations with a 1:50, 1:150, and 1:250 molar ratio of Xa to TiO₂. For the TiO₂, we incorporated pure anatase or rutile at one of two different particle sizes. In the same manner as before, we observed that within the same polymorph, the smaller particles promoted a greater change in the hue angle of the coating than the larger particles did (FIGS. 1A-1D). We previously stated that this is due to the greater surface area that the smaller particles offer. Additionally, we determined that anatase triggers a greater color change in the coatings compared to rutile (FIGS. 1A-1D). Overall, the smaller anatase particles had the greatest color change with an average hue angle shift of 26.3°, 34.6°, and 38.9° for the 1:50, 1:150, and 1:250 conditions, respectively (FIG. 1C), while the larger rutile particles had the smallest color change with an average hue angle shift of 3.3°, 3.8°, and 5.2° for the 1:50, 1:150, and 1:250 conditions, respectively (FIG. 1D).

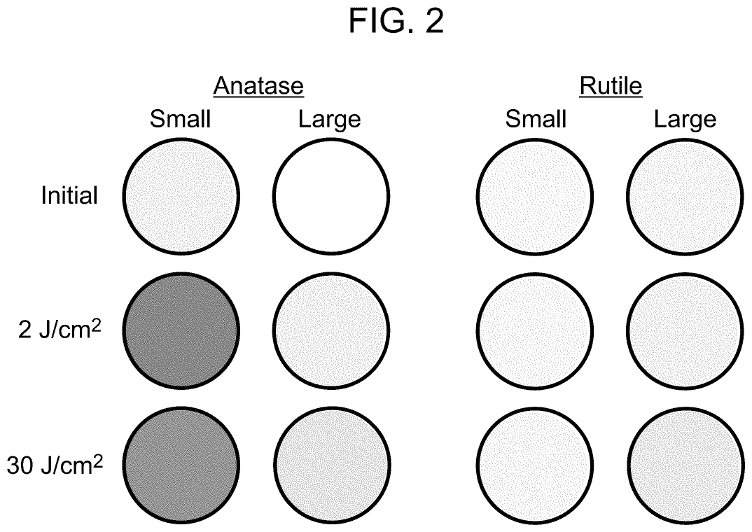

Next, we decided to investigate whether we could replace Xa with another redox-active colorant to expand the accessible color ranges we could produce, and to demonstrate that this approach is not specific to Xa. To do this, we explored how the redox-active colorant methyl viologen, in combination with different forms and sizes of TiO₂ particles in a solid-state paint matrix responded to UV irradiation. Interestingly, we only observed prominent color change from clear/white to purple when the methyl viologen was in combination with the smaller anatase particles (FIG. 2 and Table 1). There was some darkening in the coatings with the other three types of particles that caused a small change in the ΔE (i.e., color change) values in the coatings after irradiation, but the sample with the smaller anatase particles had a ΔE of 47.3 after a 2 J/cm² dosage of UVA light (Table 1). We also observed that the ΔE value of the smaller anatase sample that the purple color fades after prolonged exposure, indicating that there may be some degradation of the methyl viologen (FIG. 2 and Table 1).

TABLE 1
Color changes in viologen-based coatings with different
sizes and forms of TiO₂ after UV exposure.

| Sample | ΔE After 2 J/cm² | ΔE After 30 J/cm² |
|---|---|---|
| Small Anatase | 47.3 | 38.1 |
| Large Anatase | 3.2 | 7.3 |
| Small Rutile | 1.1 | 2.6 |
| Large Rutile | 1.4 | 6.2 |

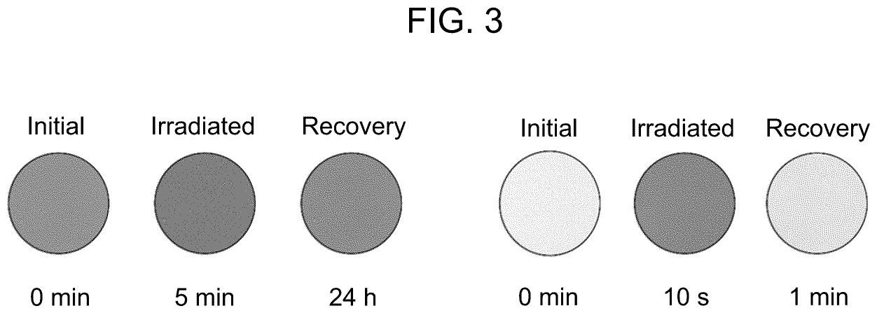

Another reason why we chose to explore other redox-active colorants in our coatings was because our previous formulations provided slow responses to the UV stimulus, requiring anywhere from 5 to 30 minutes to change color and then at least 24 hours to relax to their original color (FIG. 3A). In this disclosure, we demonstrate that we can use methyl viologen in our formulations to rapidly change the color of our coatings from clear/white to purple within seconds of UV irradiation (FIG. 3B). Furthermore, the methyl viologen coatings start to lose their purple color as soon as the UV light is removed and within 1 minute the coating color is primarily white.

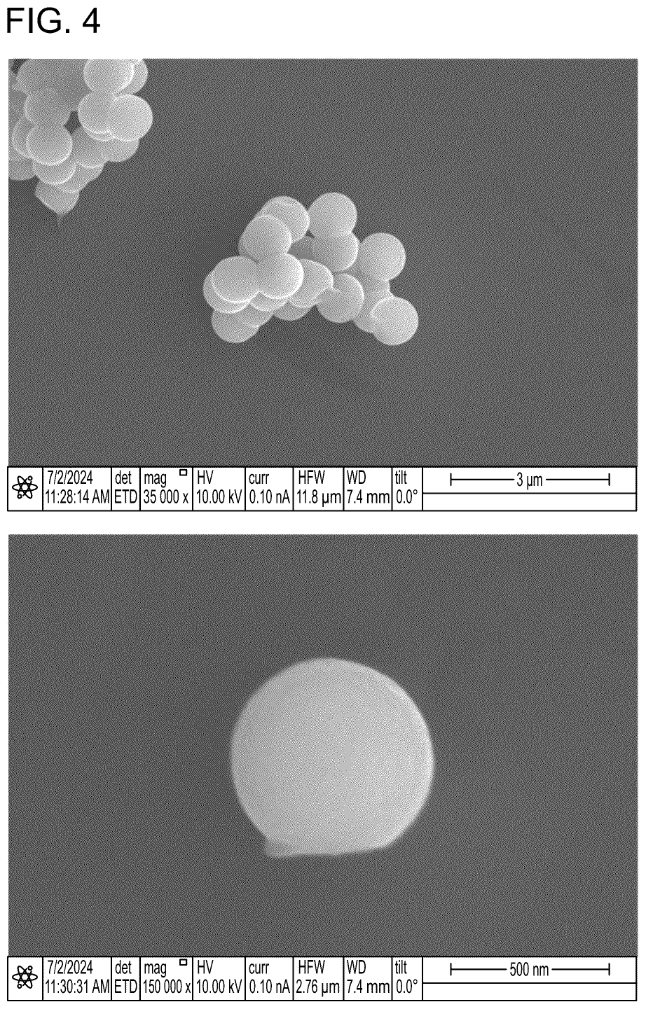

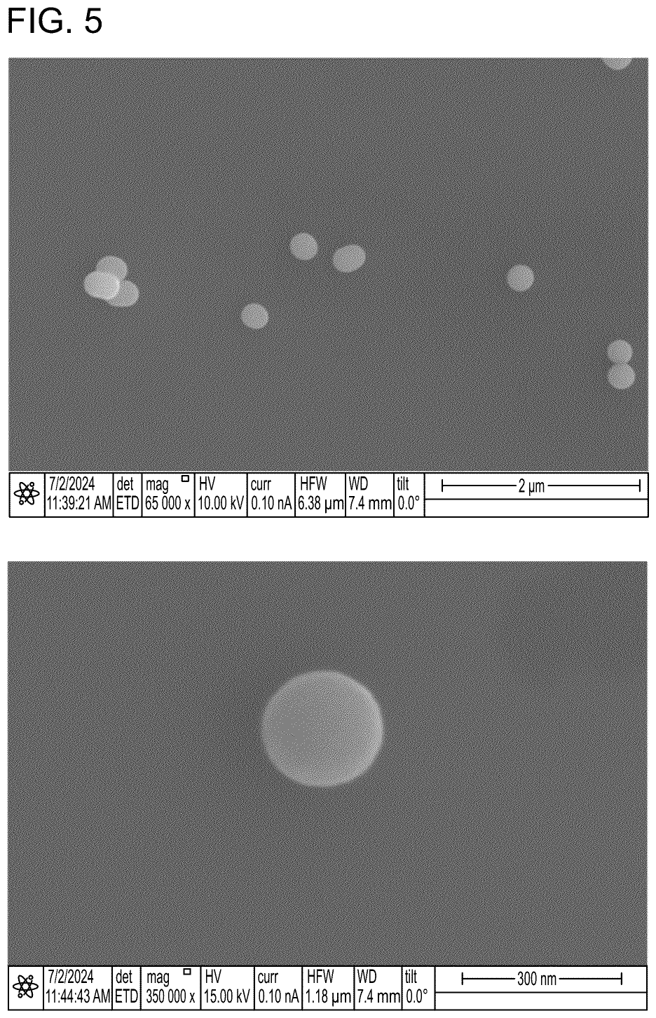

Our approach to developing coatings that could undergo color change in response to visible light involved decreasing the band gap energy of TiO₂ so that lower energies of light would still cause the electrons to be excited. To do this, we have developed a simple one pot method for synthesizing tin-doped TiO₂ (Sn—TiO₂) based on previously published protocols for synthesizing TiO₂.^{3,4} To confirm that we incorporated tin into the TiO₂ particles, we used both scanning electron microscopy (SEM) and energy dispersive spectroscopy (EDS). We produced round particles with this synthesis and the addition of the tin decreased the average particle size from 894.1 nm to 263.9 nm (FIG. 4 and FIG. 5; Table 2). Additionally, our EDS measurements confirmed that the Sn—TiO₂ particles contained a high percentage of tin and some remaining chlorine from the tin chloride (II) reagent we used in the synthesis, highlighting that we successfully incorporated tin into the TiO₂ particles (Table 3). The undoped particles were composed of titanium and oxygen (Table 3).

TABLE 2
Diameter of particle size for TiO2 particles and Sn—TiO₂ particles

| Particle Sample | Diameter of particle (nm) |
|---|---|
| TiO₂ Sample 1 | 884.9 |
| TiO₂ Sample 2 | 871.2 |
| TiO₂ Sample 3 | 859.8 |
| TiO₂ Sample 4 | 934.7 |
| TiO₂ Sample 5 | 950.6 |
| TiO₂ Sample 6 | 863.4 |
| Mean diameter (nm) of TiO2 Samples | 894.1 |
| Sn—TiO₂ Sample 1 | 227.4 |
| Sn—TiO₂ Sample 2 | 277.1 |
| Sn—TiO₂ Sample 3 | 276.9 |
| Sn—TiO₂ Sample 4 | 270.1 |
| Sn—TiO₂ Sample 5 | 251.0 |
| Sn—TiO₂ Sample 6 | 280.7 |
| Mean diameter (nm) of Sn—TiO₂ Samples | 263.9 |

TABLE 3
Energy dispersive spectroscopy (EDS) data
for TiO₂ particles and Sn—TiO₂ particles

| | Mean Apparent | Mean Weight (%) | Weight Normalized |
|---|---|---|---|
| Element | Concentration (n = 3) | (n = 3) | (%) (n = 3) |
| Oxygen (TiO₂) | 71.77 | 36.08 | 51.27 |
| Titanium (TiO₂) | 58.25 | 34.29 | 48.73 |
| Total (TiO₂) | | 70.37 | 100.00 |
| Oxygen (Sn—TiO₂) | 24.87 | 13.29 | 35.29 |
| Chlorine (Sn—TiO₂) | 3.52 | 2.07 | 5.50 |
| Titanium (Sn—TiO₂) | 18.18 | 12.11 | 32.18 |
| Tin (Sn—TiO₂) | 10.94 | 10.18 | 27.03 |
| Total (Sn—TiO₂) | | 37.65 | 100.00 |

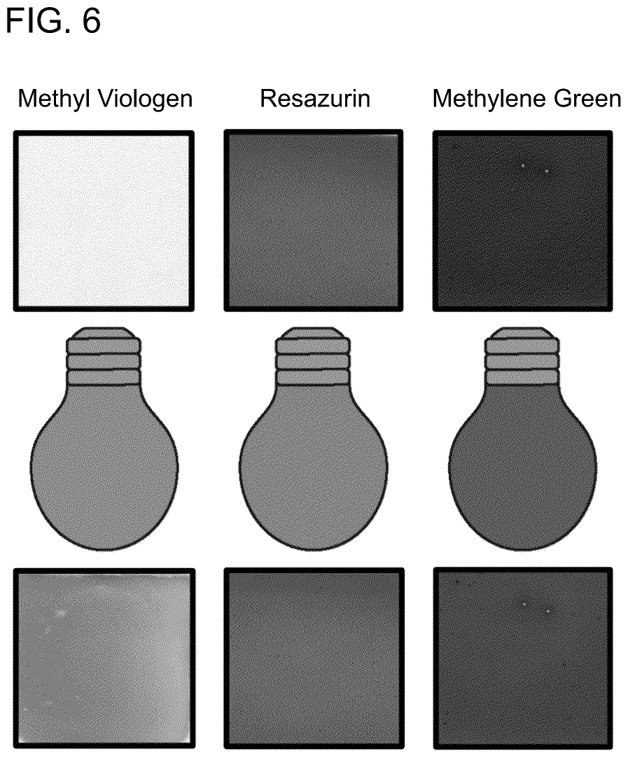

We then replaced the standard TiO₂ in our coatings with our Sn—TiO₂ nanoparticles along with redox-active dyes, such as methyl viologen, resazurin, and methylene green (FIG. 6 top images). With the addition of the Sn—TiO₂ particles, we could trigger a color change in the methyl viologen sample using blue light as opposed to UV light (FIG. 2). Out of the three coatings we prepared to irradiate with visible light, the methyl viologen had the greatest color change (Table 4). In addition, we observed color change when our resazurin and methylene samples were irradiated with green and red light, respectively (FIG. 6 and Table 4). The resazurin-based coating had the smallest color change (Table 4) of the three samples.

TABLE 4
Color changes in Sn—TiO₂ coatings with redox-active dyes
as a response to visible light after 10 minutes of irradiation.

| | Initial Hue | Final Hue | Change in Red | |
|---|---|---|---|---|
| Sample | Angle (°) | Angle (°) | Channel | ΔE |
| Methyl Viologen | −84.8 | −37.1 | 62 | 33.4 |
| Resazurin | 35.0 | 32.1 | 1 | 4.1 |
| Methylene Green | 64.8 | 46.9 | 38 | 14.5 |

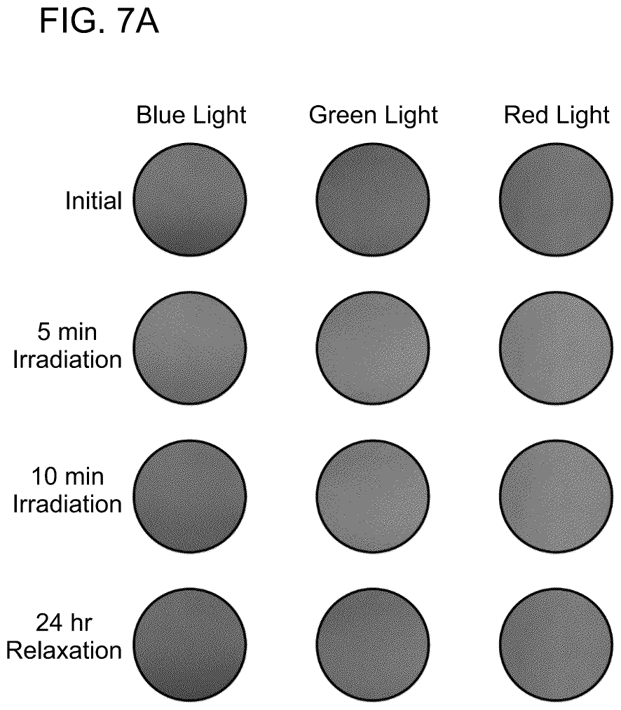

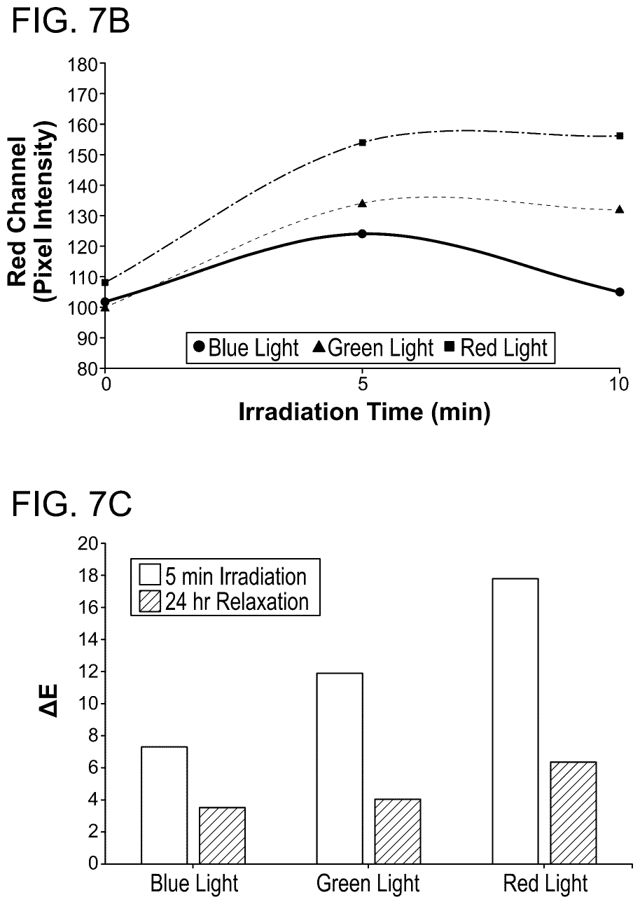

Furthermore, we combined all three redox-active pigments and the Sn—TiO₂ particles into a single coating, with the goal of making a coating that would change a different color based on the type of visible light it is exposed to (FIGS. 7A-7C). Results revealed that each color of visible light produced a different color change in the coating and exposure to red light in this case caused the greatest color change. Additionally, we wanted to see if this coating would revert to its original color in the absence of light in the same manner as our UV-responsive coatings. To determine how similar the coating color was after 24 hours of relaxation, we calculated the ΔE values of the coatings after relaxation in relation to the original coating color and compared the results to the ΔE values of the coatings after 5 minutes of irradiation in relation to the original coating color. For all samples, the ΔE values after relaxation are smaller than the ΔE values after irradiation, suggesting that there is some color recovery after 24 hours of relaxation (FIG. 7C).

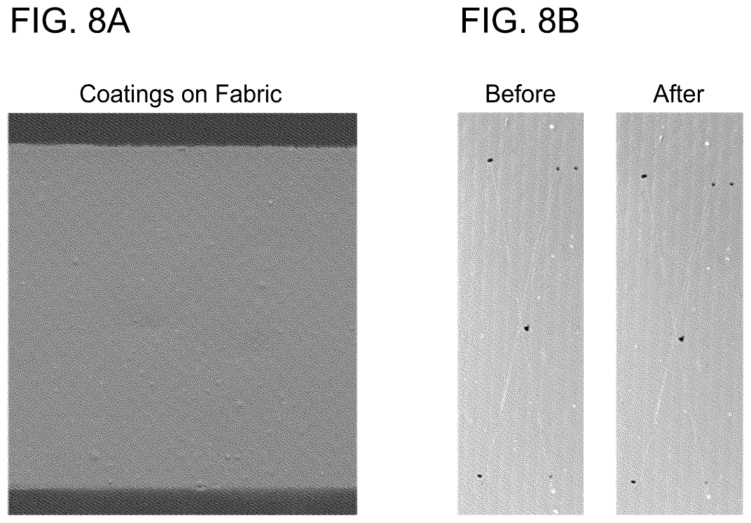

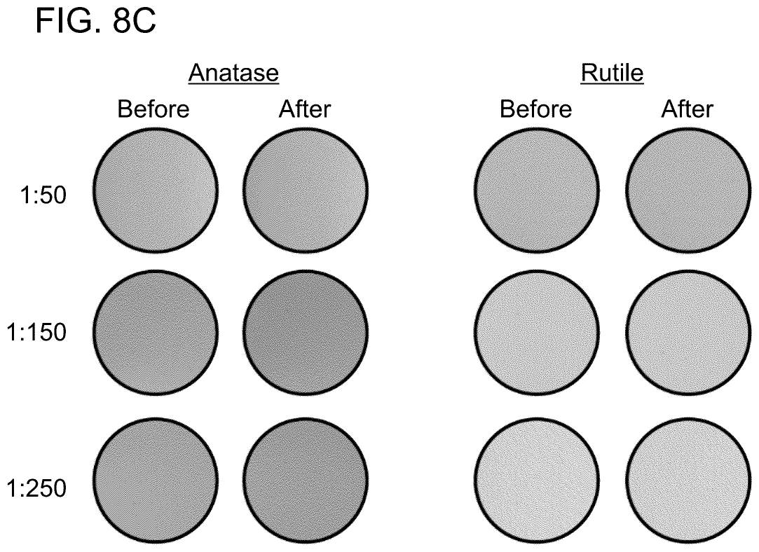

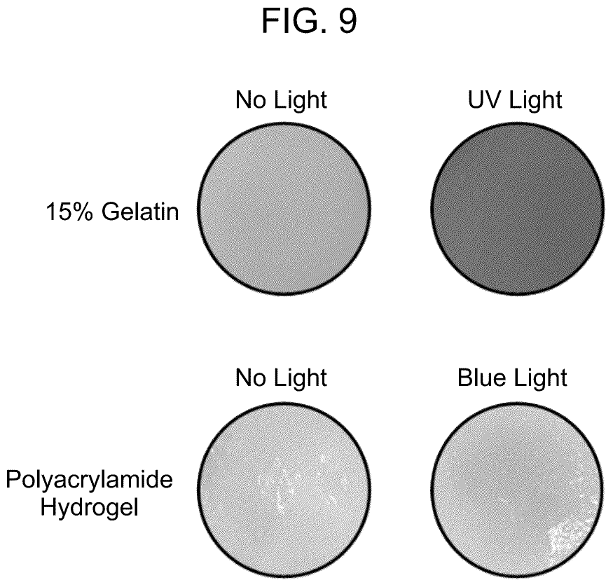

The formulations disclosed in the previously published manuscript¹ and patent application² are only compatible with rigid substrates. The compositions disclosed herein are mechanically compliant and can be grafted onto soft, flexible substrates like fabrics or hydrogels. First, we demonstrated that we can incorporate colorants and metal oxides into an acrylate-modified paint matrix that forms a flexible film when completely cured (FIG. 8A). We also highlight the compatibility of these coatings with fabric substrates by performing an X-cut adhesive test (FIG. 8B). The coating received a 5A rating, indicating that the coating can strongly adhere to the fabric and suggesting that it can maintain its integrity when the fabric undergoes mechanical deformations such as folding or stretching. Next, we combined Xa and the small particle anatase or rutile into the flexible coating at the same molar ratios as our rigid coatings that we highlight in FIG. 1 and exposed these coatings to UV light. We observed similar results to our rigid coatings, where the anatase samples had a greater color change than the rutile samples, and for the anatase samples, the conditions with higher loading densities of TiO₂ (1:150 and 1:250) had a greater color change than the 1:50 condition (FIG. 8C). Overall, these results highlight that we can translate our color-changing formulations into other types of paint matrices with different mechanical characteristics to our rigid coatings. Additionally, we incorporated methyl viologen and our Sn—TiO₂ particles into both gelatin and polyacrylamide and demonstrated that we can initiate the methyl viologen color change in these medium with both UV and blue light (FIG. 9). It is interesting to note that the methyl viologen changed blue when exposed to irradiation in the hydrogels as opposed to the purple color it turned in the solid-state matrix and may possibly be due to the amount of water in the sample.

### Experimental Methods

### Xa Synthesis

We first synthesized Xa via the cyclization of 3-hydroxykynurenine according to previously published procedures. In summary, we first suspended 3-hydroxykynurenine (0.036 mmol, 1.00 equiv) in 1.5 mL distilled water and then dissolved the reagent with 5 additions of 1 M sodium hydroxide (NaOH) (10 μL per addition). We then brought the solution up to a volume of 2 mL with distilled water. Next, we dissolved potassium ferricyanide (0.100 mmol, 2.78 equiv) in 1 mL distilled water and then added it dropwise to the 3-hydroxykynurenine solution. We then covered the sample to exclude light and stirred the solution for 1.5 hours at room temperature. Afterwards, we precipitated the product using 1 mL of 1 M hydrochloric acid (HCl), washed the product three times with chilled distilled water, and then stored it at 4° C.

### Xa-Based Photochromic Coatings Sample Preparation

We prepared these coatings by adding Xa and anatase or rutile at one of two different sizes in a 1:50, 1:150, or 1:250 molar ratio of Xa to TiO₂ in the polyurethane-based paint carrier. We first manually mixed the samples to improve pigment dispersion, and then sonicated the samples for 10 minutes and vortexed for 1 minute. We then repeated the sonication-vortexing process two additional times. We used painter's tape to make a 1×1 in² square template on a Leneta™ card and then used the film applicator and Meyer rod to apply the coating over template. We placed the samples in a vacuum jar immediately after application for 2 minutes to remove any excess bubbles in the paint. We allowed the samples to dry for 24 hours before we performed any analysis.

### Viologen-Based Photochromic Coatings Sample Preparation

For the UV-responsive coatings with viologen, we first prepared a 20 mg/mL stock solution of methyl viologen in water. Then, we added either the larger or smaller particles or either anatase or rutile at a 1:50, 1:150, and 1:250 molar ratio (methyl viologen to TiO₂) to the polyurethane-based carrier matrix. We manually mixed the sample until the TiO₂ was wetted by the paint, and then sonicated the sample for 10 minutes and vortexed for 1 minute. We then added the methyl viologen solution at the right molar ratio and did the sonication-vortexing process two additional times to thoroughly mix the sample. We then used painter's tape to make a 1×1 in² template on a Leneta™ card and applied the coating using a film applicator and Meyer rod. We placed the samples in a vacuum jar for 2 minutes to remove any excess air bubbles and then left the sample to dry for 24 hours before we performed any analysis.

### Irradiation and Analysis of UV-Responsive Photochromic Coatings

To examine the change in the paint color because of UV irradiation for both the Xa and methyl viologen coatings, we first used a flatbed photo scanner to obtain a high-resolution image (600 dpi) of the original sample. After imaging, we irradiated the sample using a UVA lamp (365 nm wavelength) at an irradiance of 9 mW/cm² until we exposed the sample to a final dosage of 30 J/cm². We removed the sample every 2 J/cm² and collected a high-resolution image to track the color change of the sample.

### Data Analysis

For these coatings, we analyzed the color change using ImageJ. We chose to use the CIELAB color space for our analysis, where L is the sample brightness (0 to 100 scale) and a and b are chromaticity values representing red to green and yellow to blue, respectively. From these values, we could calculate the hue angle (Equation 1) and ΔE values (Equation 2). ΔE is a metric that compares how similar two colors are to each other based on their L, a, and b values. The smaller the number, the closer the colors are to each other.

$$hue angle = arc tan ( \frac{b}{a} ) \qquad Equation 1$$

$$Δ E = \sqrt{{( {L}_{2} - {L}_{1} )}^{2} + {( {a}_{2} - {a}_{1} )}^{2} + {( {b}_{2} - {b}_{1} )}^{2}} \qquad Equation 2$$

### TiO₂ Synthesis

To prepare for the TiO₂ synthesis we followed a modified sol-gel method outlined in the literature.⁴ We first combined 100 mL of methanol, 50 mL of acetonitrile, 0.12 mL of distilled water, and 0.28 g of dodecylamine in a 500 mL Erlenmeyer flask. This mixture was vigorously stirred with a magnetic stir bar for 10 minutes. After 10 minutes, 1.0 mL of titanium (IV) isoproproxide was added to the solution while it was stirring. We covered the top of the flask with parafilm and let the solution stir overnight. The solution turned a milky white color. This indicates the formation of TiO₂ particles. After stirring overnight, the solution was centrifuged and washed three times with ethanol. The TiO₂ particles form a white pellet and are stored in ethanol.

### Sn—TiO₂ Synthesis

The synthesis for the Sn—TiO2 is a modified protocol the previously described TiO₂ synthesis. To prepare for the Sn—TiO₂ synthesis, we first combined 100 mL of methanol, 50 mL of acetonitrile, 0.12 mL of distilled water, and 0.28 g of dodecylamine in a 500 mL Erlenmeyer flask. This mixture was vigorously stirred with a magnetic stir bar for 10 minutes. After 10 minutes, 1.0 mL of titanium (IV) isoproproxide was added to the solution while it was stirring. The solution was left to stir vigorously for 30 minutes. A white precipitate should form and should be a milky white color. After 30 minutes, 0.731 g of tin (II) chloride is added directly to the stirring mixture. The milky white solution should turn a pale-yellow color upon the addition of the tin (II) chloride. We covered the top of the flask with Parafilm and let the solution stir overnight. After stirring overnight, the solution was centrifuged and washed three times with ethanol. The Sn—TiO₂ particles form a pale-yellow pellet and are stored in ethanol.

SEM images and EDS were used to determine if the tin was incorporated within the TiO₂. We diluted the TiO₂ and the Sn—TiO₂ in ethanol and placed ˜4 μL of the solutions on two separate silicon wafer. Imaging and EDS measurements were completed on a FEI Scios DualBeam scanning electron microscope. We measured the elements: oxygen, chlorine, titanium, and tin. The EDS measurements of the control, TiO₂, did not have tin or chlorine. The presence of tin and chlorine suggests that the tin (II) chlorine interacted with the TiO₂ during synthesis (Table 3). Other elements such as silica and rubidium were measured but were disregarded as they were measurements of the silicon wafer the sample was prepared with. Here we measured and reported on the normalized weight percents of each element.

### Sample Preparation for Visible Light Responsive Coatings

Rust-Oleum® is used as the base paint throughout all the samples. This paint allows for adequate homogenization of dyes and Sn—TiO₂ in the paint. We used redox dyes in each sample. Each sample contains a mixture of Rust-Oleum®, distilled water, dye, and Sn—TiO₂. A stock solution of 7.0 grams of Rust-Oleum® is combined with 0.5 mL of distilled water along with 2 mg/mL of dye. The paint sample was mixed thoroughly by vortex for a minute followed by sonication for 10 minutes. This was repeated three times. This creates a 7.5 g stock solution of paint. The Sn—TiO₂ is divided into small amounts in 2.0 mL microcentrifuge tubes. One gram of the paint solution was added to the Sn—TiO₂ and was mixed thoroughly by vortex for a minute followed by sonicating for 10 minutes. This is repeated three times to ensure the Sn—TiO₂ is fully incorporated into the paint. The paint mixture is applied to a paper Leneta™ card using a film applicator. The paint is left to dry overnight.

### Preparation and Irradiation of Photoresponsive Xa-Based Flexible Coatings

To prepare our coatings that we applied to fabrics, we mixed the acrylate-modified paint matrix with either small particle anatase or rutile TiO₂ in a 1:50, 1:150, and 1:250 molar ratio of Xa to TiO₂. We then dissolved the desired amount of Xa in distilled water (0.1 g of water for 1 g of paint) and added the solution to the paint sample. We then sonicated the sample for 10 minutes, followed by 1 minute of vortexing and we repeated this process a total of 3 times. We then applied the coating on a 1×1 in² space on a Leneta™ card using a film applicator and Meyer rod. The UV irradiation and analysis protocols for these coatings are the same as the rigid coatings described above. We also applied coatings prepared in a similar manner onto fabric substrates using either a film applicator or a spray gun.

### Adhesion Test

We performed an X-cut tape test in accordance with the ASTM Designation D3359-17 Test Method D3330/D3330M on the flexible, acrylate-modified coatings on the fabric substrate.

### Sn—TiO₂ and Methyl Viologen in a Gelatin Solution

To create a color changing gelatin solution, a stock of 15% gelatin was combined with Sn—TiO₂ and 2.0 mg/mL of methyl viologen. The solution was transferred to a mold and allowed to cure. Once cured the solution was exposed to UV light and the color change was noted qualitatively (FIG. 9A).

### Sn—TiO₂ and Methyl Viologen in a Polyacrylamide Hydrogel

To create a color changing polyacrylamide hydrogel, a mixture of 100 mg/ml of acrylamide and 4.5 mg/ml of bis-acrylamide was combined in 8.4 mL of water and vortexed thoroughly. This will create a 10 mL stock solution. The Sn— TiO₂ and 2 mg/mL of methyl viologen was added to the above stock solution. The solution was vortexed thoroughly then sonicated for 10 minutes. An aqueous 10% ammonium persulfate solution was added as the initiator to the solution. Then, increasing volumes of TEMED was added to the solution above until the gel cured in a mold. Once cured the hydrogel was exposed to blue light and the color change was recorded quantitatively (FIG. 9B).

### REFERENCES

1. Martin, C. L, Flynn, K. R., Kim, T., Nikolic, S. K., Deravi, L. F., Wilson, D. J. Color-changing Paints Enabled by Photoresponsive Combinations of Bio-inspired Colorants and Semiconductors. Advanced Science, 10, 2302652 (2023).
2. Flynn, K. R., Martin, C. L., Deravi, L. F. & Wilson, D. J. Suspensions and Solutions of Dyes For Colored Coatings. WO/2023/244981 (PCT Appl. No. PCT/US2023/068308). Filed Jun. 12, 2023.
3. Zhang, Y. et al. Visible-Light-Responsive Photoreversible Multi-Color Switching for Rewritable Light-Printing and Information Display. Small 20, 2310962 (2024).
4. Zheng, J. et al. Photochromism from wavelength-selective colloidal phase segregation. Nature 617, 499-506 (2023).

### INCORPORATION BY REFERENCE; EQUIVALENTS

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A composition comprising:
a) tin-doped titanium dioxide (Sn—TiO₂) nanoparticles;
b) a redox-active dye that changes color from exposure to ultraviolet (UV) light, visible light, or a combination thereof; and
c) a paint matrix.

2. The composition of claim 1, wherein the paint matrix comprises a polymeric binder and water.

3. The composition of claim 2, wherein the polymeric binder is a polyurethane, polyamide, polyester, polysaccharide, polyethylene glycol, polyacrylate, polymethacrylate, or nitrocellulose.

4. The composition of claim 2, wherein the polymeric binder is nitrocellulose.

5. The composition of claim 4, wherein the composition is a nail polish.

6. The composition of claim 1, wherein the redox-active dye is methyl viologen, resazurin, or methylene green.

7. The composition of claim 1, wherein the color change is induced by blue light, green light, or red light.

8. The composition of claim 7, wherein the blue light has a wavelength from about 450 nm to about 495 nm.

9. The composition of claim 7, wherein the green light has a wavelength from about 495 nm to about 570 nm.

10. The composition of claim 7, wherein the red light has a wavelength from about 620 nm to about 650 nm.

11. The composition of claim 1, wherein the normalized weight percentage of tin in the Sn—TiO₂ particles is about 20% to about 35%.

12. The composition of claim 1, wherein the Sn—TiO₂ particles have a diameter of about 150 nm to about 350 nm.

13. The composition of claim 1, wherein the redox-active dye is methyl viologen and the color change comprises a ΔE of about 33.4 and a change in hue angle of about +47.7°.

14. The composition of claim 1, wherein the redox-active dye is resazurin and the color change comprises a ΔE of about 4.1 and a change in hue angle of about −2.9°.

15. The composition of claim 1, wherein the redox-active dye is methylene green and the color change comprises a ΔE of about 14.5 and a change in hue angle of about −17.9°.

16. The composition of claim 1, further comprising a polyacrylamide hydrogel.

17. The composition of claim 1, further comprising acrylamide and bis-acrylamide.

18. The composition of claim 1, further comprising gelatin.

19. The composition of claim 1, wherein the composition is adhered to a flexible substrate.

20. A composition comprising:
a) TiO₂ nanoparticles, wherein the TiO₂ nanoparticles are at least 80% anatase;
b) a redox-active colorant that changes color from exposure to ultraviolet (UV) light, visible light, or a combination thereof; and
c) a paint matrix.

21. The composition of claim 20, wherein the color change comprises a ΔE of about 3.0 to about 48.0 after excitation of about 2 J/cm² or a ΔE of about 7.0 to about 40.0 after excitation of about 30 J/cm².

22. A composition comprising:
a) TiO₂ nanoparticles, wherein the TiO₂ nanoparticles are at least 80% rutile;
b) redox-active colorant that changes color from exposure to ultraviolet (UV) light, visible light, or a combination thereof; and
c) a paint matrix.

23. The composition of claim 22, wherein the color change comprises a ΔE of about 1.0 to about 2.0 after excitation of about 2 J/cm² or a ΔE of about 3.0 to about 7.0 after excitation of about 30 J/cm².
